(19) United States
(12) Patent Application Publication
(10) Pub. No.: US 2011/0198878 A1
(43) Pub. Date: Aug. 18, 2011

(54) Portable Horse Paddock

(75) Inventor: Todd Maley, Wausau, WI (US)

(73) Assignee: MALEY MANUFACTURING LLC, Wausau, WI (US)

(21) Appl. No.: 13/024,949

(22) Filed: Feb. 10, 2011

Related U.S. Application Data
(60) Provisional application No. 61/304,172, filed on Feb. 12, 2010.

(51) Int. Cl. B60P 3/04; A01K 3/00; B65H 75/34

(52) U.S. Cl. 296/24.31; 256/10

(57) ABSTRACT

A mobile electrified fence enclosure system utilizing multiple movable storable fence posts and flexible electrified ribbons what are retractably reeled into a spool. The electrified ribbons are detachably connected electrically by means of a breakaway connector which interrupts the voltage should the animal bolt through the wiring. The system is preferably stored in or attached to a trailer, such as a horse trailer, and is quickly and easily set-up and taken-down.

### CROSS REFERENCE TO RELATED APPLICATIONS

This application claims priority from U.S. provisional application No. 61/304,172 filed 12 Feb. 2010; the entire contents being hereby included by reference and for which benefit of the priority date is claimed.

### FIELD OF THE INVENTION

The present invention relates to a method and apparatus for enclosing animals, particularly horses. More specifically, an enclosure system for use at a remote site, which may be used in or out of conjunction with a horse or livestock trailer.

### BACKGROUND OF THE INVENTION

In the past, horses have been tied to some sort of anchor such as a tree, rock, post or shrub for the night to keep them from wandering off. This is stressful to the animal which feels more comfortable if they can wander and graze through the night.

If possible, the rider may find some sort of corral or make shift fence to constrain the animal. This can become an involved and limiting process which typically fails at some time during the night leading to the animal breaking free and wandering about.

Various electrical and electronic devices are used nowadays to keep the animal confined to an area typically associated with a trailer which is used to transport the animal. At times it is desirable to have this portable corral or paddock juxtaposed to the trailer to take advantage of one of the walls or sides to form part of the enclosure. At other times, it may also be advantageous to dissociate the paddock from the trailer due to space constraints or desirability of nearby areas for superior grazing or the like. The theory of operation of the electric fence is to deliver a high voltage low power (amperage) shock to the animal to teach the animal to be respectful of the boundary.

Others in the art have taught to integrate a power source and high voltage unit as part of a fence post assembly. One problem associated with a power source in the fence post is the fragility of such a system. Stakes should be sturdy enough to be pounded in to the ground without fear of breaking or damaging circuits or electrical connections.

Structures such as an electric fence are not designed to physically restrain an animal, but rather to provide an enclosure having a boundary or perimeter which is respected. An animal, such as a horse, can be startled in a strange environment, to the point where almost any preventative electric fence is inadequate to hold or restrain the animal. Once the startled animal runs through an electric fence, any electronics associated with fence posts can be crushed by the weight of the animal. Further should an animal take a section of fence with a continued electric charge as taught in the prior art, the charge will continue to move through and further excite the animal, such a condition would only further aggravate the situation causing further danger and harm to the animal and damage to property.

Others may teach to have electronic controls built into the trailer itself. This can require extensive and expensive modification to the trailer, and greatly inhibit the paddock from being used remotely from the trailer. Further simply attaching electronic controls to the trailer does not address the issue of continued electric charge.

### SUMMARY OF THE INVENTION

Therefore it is desired to have an invention which as that outlined in this disclosure comprising a multiple of new features and advantages not found in the prior art. Below are listed several of these advantages. This is, by no means, a comprehensive list of advantages.

It is an advantage of the invention to provide a paddock area for animals apart from, but adjacent to, a trailer.

It is a further advantage to provide a fencing structure which can be used in conjunction with a trailer, or easily modified to use the structure as a stand alone.

It is a further advantage to provide a system wherein the high voltage circuit is disabled should a startled animal bolt and run through a section of the fence.

It is a further advantage to provide a system wherein the a section of electrical ribbon can be detached from the spool.

It is a further advantage to provide a system where damage portions of the fence are easy to replace.

It is a further advantage to provide a system where electronics are kept separate from animal containment structures such as a fence post.

It is a further advantage to be able to hook up power to a battery in the trailer for backup when required.

### BRIEF DESCRIPTION OF THE DRAWINGS

A sufficient understanding of the present invention may be obtained by reference to the accompanying drawings, when considered in conjunction with the subsequent, detailed description, in which:

FIG. 1 is a perspective view of one embodiment of a horse containment system of the present invention in conjunction with a horse trailer;

FIG. 2 is a partial perspective view of the embodiment of FIG. 1 showing a sturdy box having a high voltage generation unit;

FIG. 3 is a partial perspective view of the embodiment of FIG. 1 detailing a preferred example of a spool, electronic ribbon and connection structure;

FIG. 4 is a perspective view of an alternate example of the system being used in a remote location;

FIG. 5 is a perspective view taken from FIG. 4 wherein the large animal has bolted or fled;

FIG. 6 is a schematic view of an embodiment showing two enclosures in tandem wherein the trailer forms a portion of the enclosure;

FIG. 7 is a schematic view of an alternate embodiment showing three enclosures in tandem wherein the trailer forms a portion of the enclosure;

FIG. 8 is an exploded view of the handle and spindle assembly of the spool assembly;

FIG. 9 is a perspective view showing one method of assembly for the spool.

### DETAILED DESCRIPTION

The Figures to follow show a generally preferred embodiment of the present invention being a mobile paddock attached to the outside wall of a trailer with an alternative embodiment wherein the paddock stands alone.

Some components of the invention can be integrated with a vehicle which may be in the form of a trailer (100) having a chassis and having an integrated box or compartment. In these instances the trailer may provide a power supply.

In another embodiment, the structure may comprise a sturdy box (120) which is separate from the trailer (100). The sturdy box (120) is preferred to be of hardened Aluminum but can be of steel or stainless steel construction or wood or other materials, and is preferred to be of sturdy constructions so as to withstand substantial abuse such as being kicked by a horse. The box (120) should be large enough for holding and protecting the high voltage generation unit and like components. The box (120) is generally adapted with fixed, or reconfigurable, surfaces and shelves. It is preferable that the box (120) have room for the storage of various components such as; a high voltage generation unit (140), a plurality of insulated posts (130), at least one electrical ribbon (110) which is generally encased in a spool assembly (102), at least one gate assembly (114), and each spool assembly (102) having a corresponding jumper wire (106) with a breakaway connector (108).

The high voltage generation unit (140) which may also be referred to as a fencer, can be of commercial assembly such as a Yellow Jacket Fencer™ by Zereba Systems™ or suitable equivalent and should be capable of providing approximately 3,000 to 5,000 volts with very low current output. Additionally the high voltage generation unit (140) can be of pulsed application.

The plurality of posts (130) should be of electrically insulating material and preferably ½ to 1 inch in diameter and 40 to 50 inches in length and of sturdy, solid, construction to be driven into the ground by some depth.

The electrical ribbon (110) can be of wire, woven ribbon, and the like, and should generally by compatible with the fencer.

The spool assembly (102) is generally cylindrical in shape and should be of sturdy construction even solid material such as high molecular weight plastic or the like and able to sustain abuse from a heavy animal up to 500 Kg. The spool assembly (102) can also comprise a lever arm (103) connected with a spindle with a handle mechanism (104) for winding and unwinding lengths of electrical ribbon (110). The spool assembly (102) can also have an attachment block (152) for offsetting the spool (102) during mounting by means of a spool bracket (154) which may utilize a pin (not shown) to establish the connection to a structure such as the side wall of a trailer. The spool assembly (102) can also have a orifice (150) opening or slit for extracting lengths of electrical ribbon (110).

The gate assembly typically comprises a gate latch (112) which is typically a plastic handle with a metal hook which conducts electricity to complete the circuit on the fence, and a gate spring (114) which is also conductive. Those skilled in the art will realize there are many suitable and roughly equivalent structures for providing these elements.

The jumper wire (106) is typically comprised of a 12 to 14 gauge, solid, braided, or twisted electrical wiring having an insulating sheath. The jumper wire is typically connected with the high voltage generation unit (140) by means of a wing nut or other suitable electrical connector. The breakaway connector is preferred to be an alligator clip commonly used in battery jumping cables, but can also be formed of a spring, clamp, snap, latch, pin, or the like.

The box (120) can further comprise a compartment of sturdy construction for protecting said electronics from damage by a large animal. The compartment may have power generation capabilities, such as batteries, or plug directly into an external power source. This may also provide power to lights, a sound device attached and used in conjunction with the circuits of the fence to alert the rider should a problem arise or any other additional needs.

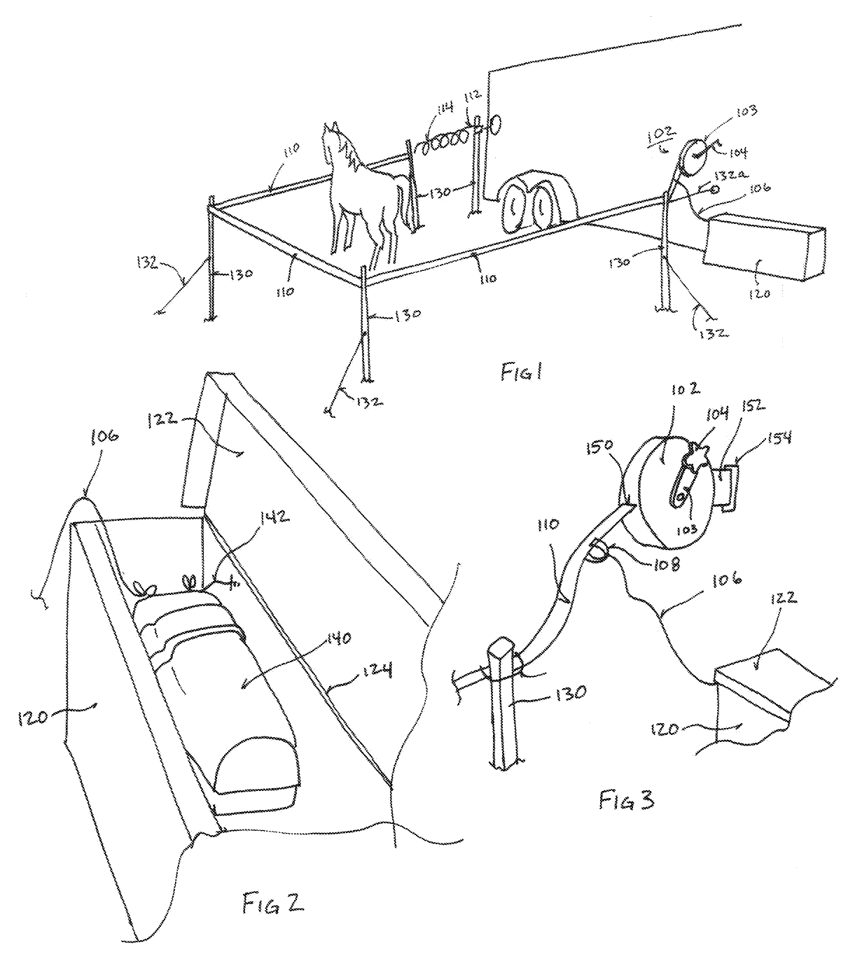

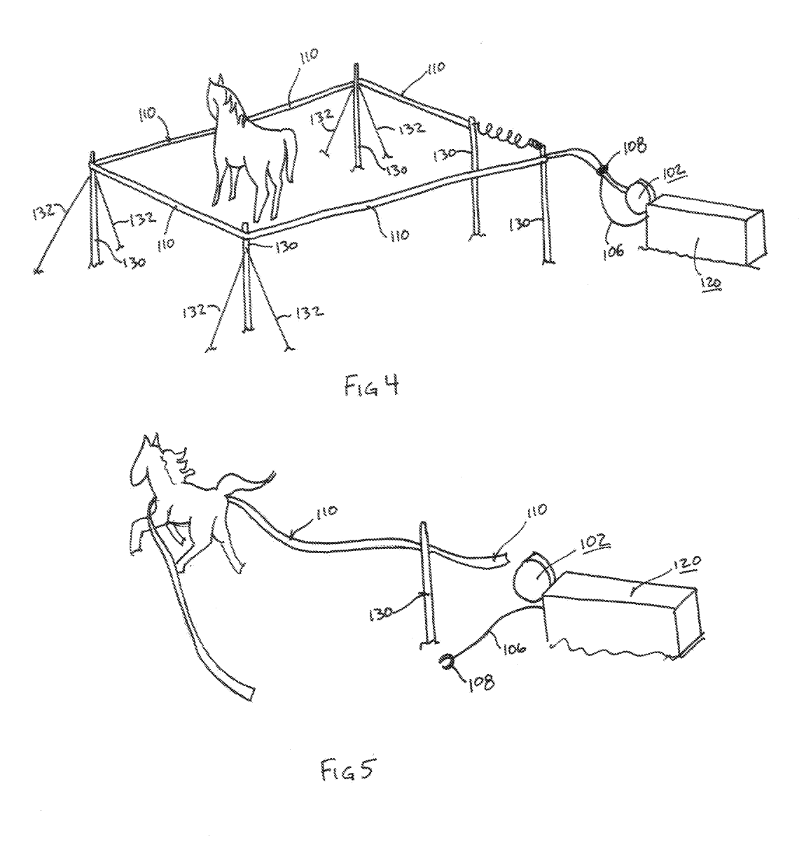

FIG. 1 shows a trailer (100) having a box (120). The trailer (100) is generally electrically grounded with the box (120) being grounded through the trailer (100). The box can be removably mounted to the side of the trailer (100) and stored in a convenient location. Extending from the box (120) is an jump wire (106) which provides an electrical connection and communicates an electrical signal between a high voltage generating unit (140) and a detachable connector (108) which is in communication with an electrical ribbon (110) as shown in FIGS. 2 and 3.

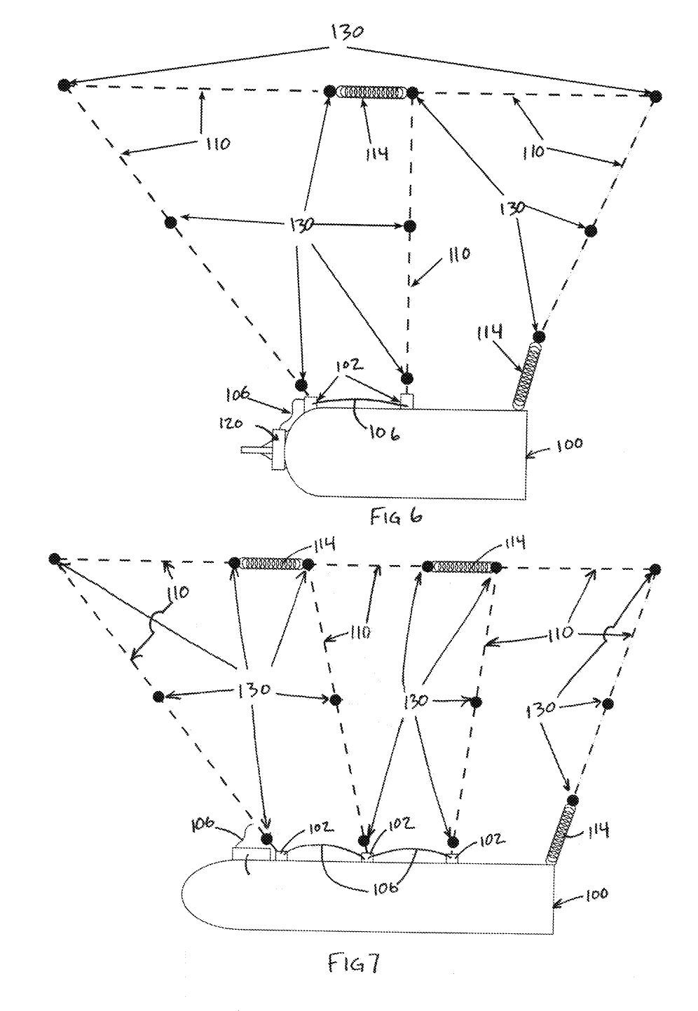

As illustrated in FIG. 5, a distinct advantage to having a detachable connector (108) in conjunction with the system is that under the conditions of an animal, such as a horse, becoming startled or agitated to the point of fleeing from its immediate environment, also known as bolting, typical electric fences are not sufficiently strong or sturdy to hold the animal, and the ribbon (110) which previously defined the boundary will likely be pulled along. In a preferred design, the breakaway connector (108) becomes disconnected which opens the circuit to electrically detach from the electrical ribbon (110). Further, should the animal continue, the electrical ribbon (110) will eventually pull free from the spool (102). Once back under control, the electrical ribbon, (110) can be taken back to the spool (102) and be rewound. This becomes an important advantage over the prior art such as where the electrical functionality is inherently integrated into the structure.

As shown in FIGS. 6 and 7, it may be desirable to mount an insulated enclosure (102) to a vertical wall on the side of a trailer (100) or other suitable location. The enclosure (102) should preferably have some means for spooling an electrical ribbon (110) such as an orifice (150) through-which to extract sufficient electrical ribbon (110) and having a winding means such as a lever (103) and handle (104) and further having some manner of attachment block (152) and attachment hardware (154) are provided.

In conjunction with the insulated enclosure (102), a series of posts (130), preferably being electrically insulated, are spaced at distances and shapes typically using at least one vertical wall of the trailer (100) as determined by the rider, but generally 10 to 15 feet on center. A typical perimeter would be less than 90 feet in length and coordinated with the length of electrical ribbon (110). A gate latch (112) and gate spring (114) can also be deployed. Preferably in an arrangement such that the gate is right next to the trailer so that the remainder of the fence remains connected to the high voltage generation unit (140). Those skilled in the art will recognize that Kirchoff's laws can be used to devise multiple suitable configurations with this regard.

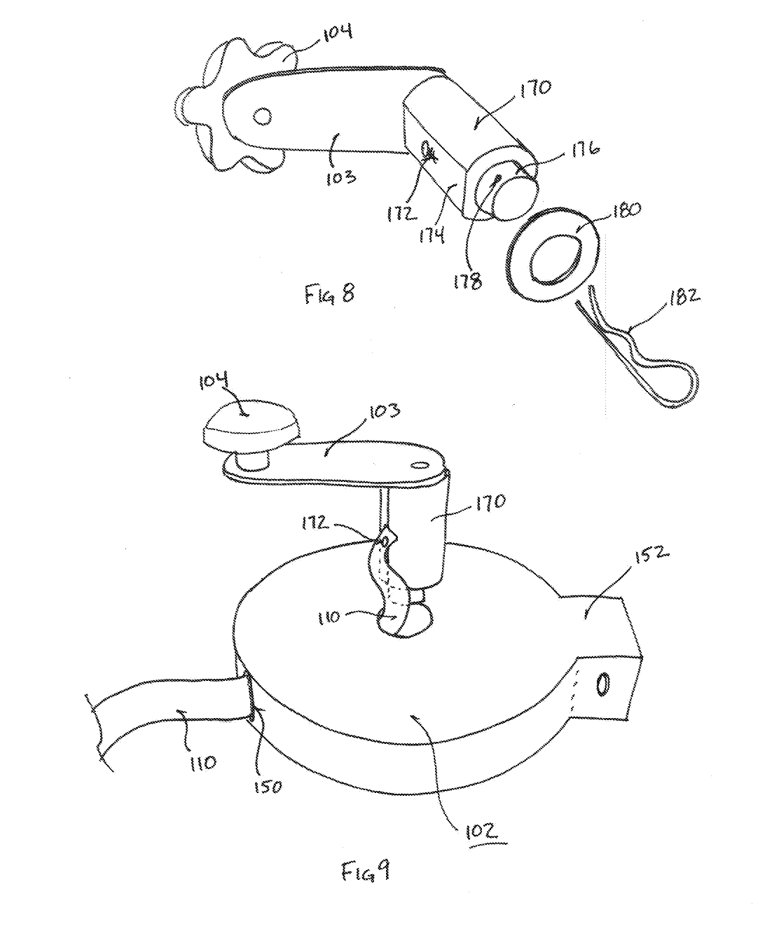

One possible configuration for connecting an electrical ribbon (110) with the spool assembly (102) in such a fashion as to release the electrical ribbon (110) from the spool (102) under the condition of a bolting animal bolting through the fence. In FIG. 8 a handle (104) is connected with a lever (103) which is connected with a spindle (170). In this instance, the spindle (170) comprises a flat region (174) to provide room for tucking the ribbon (110) as shown in FIG. 9. A fastener (172), such as a screw or equivalent structure for fastening, is provided. A reduced portion (176) is provided for protruding through the back end of the spool (102) casing and in this instance a washer (180) and clevis pin (182) is provided for fastening. An assembly is accomplished by threading the electrical ribbon (110) through the orifice (150) and to the flat (174) where it is connected by means of the fastener (172). The spindle (170) is tucked in to the spool assembly (102) and the mounting block (152) is then used to mount the spool.

An electrical ground (124) and power source such as batteries or a generator, not shown, are provided in order to complete and provide power to the circuitry. The box (120) can either be mounted to the trailer (100) or be remotely deployed and set on the ground as shown in FIG. 4. In either case it is desired that the circuitry deliver approximately 2900 to 5100 volts for a circuit formed between an electrical ribbon (110) and electrical ground. The trailer (100) can be modified to provide backup circuits or batteries, such as trailer or car batteries, to the system, but this is not required.

In accordance with FIG. 5, the current system can be configured to provide a multiple of paddock spaces powered from one box (120)

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

For example, although the foregoing refers to ______, it is contemplated that the ______. Further, riser details may vary from excavator model to excavator model in terms of dimensions and exact position of riser structural members, depending on the physical arrangement of the excavator structural members, as well as the excavator machine mass.

In other embodiments there may be a plurality of lateral structural support members greater than two coupled together to act substantially as one member.

Having thus described the invention, what is desired to be protected by Letters Patent is presented in the subsequent appended claims.

We claim:

1. A modular temporary enclosure apparatus having multiple configurations for enclosing at least one animal; the enclosure comprising:
(i) a sturdy box housing a high voltage generation unit in a protected fashion,
(ii) an enclosure comprising; a plurality of insulated posts being spaced at predetermined locations, at least one electrical ribbon being removably attached to the plurality of posts and the electrical ribbon being arranged to form a perimeter at a predetermined distance above the physical ground;
(iii) the enclosure further comprising a gate assembly being in electrical connection with the electrical ribbon for allowing passage across the perimeter of the enclosure,
(iv) the high voltage generation unit comprising a first terminal being firmly connected to electrical ground through the sturdy box and a second terminal being detachably connectable with the electrical ribbon by means of a jump wire and connector;
(v) the connector being designed to disconnect from the electrical ribbon under the force of a bolting animal.

2. A temporary enclosure apparatus in accordance with claim 1 further comprising; an insulated spool assembly, the spool assembly comprising a spindle for winding and unwinding lengths of the electrical ribbon.

3. A temporary enclosure apparatus in accordance with claim 1 wherein the electrical ribbon pulls free of the spool assembly under predetermined conditions.

4. A temporary enclosure apparatus in accordance with claim 2 wherein the sturdy box is of sufficient size to provide storage of contents, the contents comprising at least one of;
(i) the high voltage generation unit,
(ii) the plurality of insulated posts,
(iii) the electrical ribbon,
(iv) the spool assembly,
(v) the gate assembly,
(vi) the breakaway connector.

5. A temporary enclosure apparatus in accordance with claim 4 wherein the sturdy box is located outside the perimeter of the enclosure by a predetermined distance.

6. The temporary enclosure apparatus in accordance with claim 4 further comprising an animal trailer having a multiple of vertical walls of sturdy construction, wherein the sturdy box is suitable for mounting to a vertical wall of the animal trailer.

7. A temporary enclosure apparatus in accordance with claim 6 wherein the sturdy box is sufficient to protect the contents from the actions of a large animal.

8. The temporary enclosure apparatus in accordance with claim 6 wherein at least on vertical wall of the trailer forms a portion of the enclosure.

9. The temporary enclosure apparatus in accordance with claim 8 wherein the gate assembly interacts with at least one vertical wall of the trailer to form a passageway for a large animal in an open position and serves to further provide tension to the electrical ribbon in a closed position.

10. A system for enclosing at least one large animal comprising;
(i) providing an enclosure comprising; placing a plurality of insulated posts at predetermined positions defining an area of ground, attaching at least one electrical ribbon to the insulated posts at a predetermined height from the ground in order to form a perimeter over the defined area of ground,
(ii) a high voltage generation unit being protected inside a sturdy box, the high voltage generation unit comprising at least a first terminal being firmly connected to electrical ground and a second terminal being firmly connected to a jump wire,
(iii) the jump wire being connected to breakaway connector and the breakaway connector being detachably connectable to at least one electrical ribbon,
(iv) the breakaway connector designed to electrically disconnect from the high voltage generation unit under the force of a bolting animal
(v) a means for allowing the passage of the at least one large animal across the perimeter of the defined area of ground under preset conditions.

11. A system for enclosing at least one large animal in accordance with claim 10 wherein the high voltage generation unit provides an effective voltage of 2900 and 5100 volts between the first terminal and the second terminal.

12. A system for enclosing at least one large animal in accordance with claim 11 wherein the jump wire is electrically insulated.

13. A system for enclosing at least one large animal in accordance with claim 12 further having a first and a second electrical ribbons, the first electrical ribbon being connected to the first terminal and the second electrical ribbon being connected to the second terminal through a second jump wire.

14. A system for enclosing at least one large animal in accordance with claim 12 wherein the predetermined height for attachment of the electrical ribbon corresponds approximately to between the chest and shoulder height of the large animal.

15. A system for enclosing at least one large animal in accordance with claim 14 a portion of the enclosure is formed by a vertical wall of an animal trailer.

16. A system for enclosing at least one large animal in accordance with claim 15 wherein the defined area of ground is further defined as an original area of ground and being further expanded to enclose at least one additional defined area of ground in tandem with the original area of ground.

17. A system for enclosing at least one large animal in accordance with claim 16 wherein the perimeter of either the original area of ground or the at least one area of ground in tandem with the original area of ground is approximately 90 linear feet.

18. A system for enclosing at least one large animal in accordance with claim 13 further comprising an insulated spool for housing the at least on electrical ribbon.

19. The system for enclosing at least one large animal in accordance with claim 18 wherein, if the condition is met that the animal bolts, the electrical ribbon releases from the spool.

20. A modular temporary enclosure apparatus having multiple configurations for enclosing at least one animal; the enclosure comprising:
(i) a sturdy box being of sufficient size to provide storage contents,
(ii) said storage contents comprising; a high voltage generating unit, a plurality of insulated posts, at least one electrical ribbon of a length sufficient to frame a perimeter of an area, said ribbon being housed in a spool assembly, a gate assembly, and a breakaway connector, in a protected fashion,
(iii) the storage contents being able to form an enclosure comprising; the plurality of insulated posts spaced at predetermined locations, the at least one electrical ribbon being removably attached to the plurality of posts and the electrical ribbon being arranged to form a perimeter at a predetermined distance above the physical ground corresponding to the a height approximately between the chest and shoulder height of the large animal;
(iv) the enclosure further comprising a gate assembly being in electrical connection with the electrical ribbon for allowing passage across the perimeter of the enclosure,
(v) the sturdy box being located outside the perimeter of the enclosure by a predetermined distance and;
(vi) the high voltage generation unit comprising a first terminal being firmly connected to electrical ground through the sturdy box and a second terminal being detachably connectable with the electrical ribbon by means of a jump wire and connector;
(vii) the connector being designed to remain connected to the electrical ribbon and provide a provide a shock to a large animal in contact with the electrical ribbon and the ground,
(viii) the connector being designed to disconnect from the electrical ribbon should the force of the animal become excessive.
